(19) United States
(12) Patent Application Publication
(10) Pub. No.: US 2025/0203278 A1
(43) Pub. Date: Jun. 19, 2025

(54) ELECTROACOUSTIC TRANSDUCER, ARRAY SPEAKER, WEARABLE DEVICE, SPEAKER, AND ULTRASONIC TRANSMITTER

(71) Applicants: Wataru YOKOTA, KANAGAWA (JP); Shuichi SUZUKI, KANAGAWA (JP); Yuta WATANABE, KANAGAWA (JP)

(72) Inventors: Wataru YOKOTA, KANAGAWA (JP); Shuichi SUZUKI, KANAGAWA (JP); Yuta WATANABE, KANAGAWA (JP)

(21) Appl. No.: 18/976,357

(22) Filed: Dec. 11, 2024

(30) Foreign Application Priority Data
Dec. 19, 2023 (JP) 2023-213605

(51) Int. Cl. H04R 1/28; H04R 1/10; H04R 7/04; H04R 7/18; H04R 17/00

(52) U.S. Cl. CPC H04R 1/2896; H04R 1/10; H04R 7/04; H04R 7/18; H04R 17/00; H04R 2201/003; H04R 2400/11

(57) ABSTRACT

An electroacoustic transducer includes a diaphragm, a driver, a support, and a coupler. The diaphragm extends in an extending direction. The driver extends in the extending direction and is opposed to the diaphragm in an opposing direction orthogonal to the extending direction. The driver includes multiple driving sources to vibrate the diaphragm in the opposing direction. The support is disposed at a center of the multiple driving sources in the extending direction to support the driver. Further, the support is disposed in a region where the diaphragm is disposed in the extending direction. The coupler couples the diaphragm and the driver in the opposing direction. Each of the multiple driving sources of the driver extends from the support in the extending direction.

### CROSS-REFERENCE TO RELATED APPLICATION

This patent application is based on and claims priority pursuant to 35 U.S.C. § 119 (a) to Japanese Patent Application No. 2023-213605, filed on Dec. 19, 2023, in the Japan Patent Office, the entire disclosure of which is hereby incorporated by reference herein.

### BACKGROUND

### Technical Field

The present disclosure relates to an electroacoustic transducer, an array speaker, a wearable device, a speaker, and an ultrasonic transmitter.

### Related Art

Currently, acoustic devices such as earphones have been developed for use in, for example, listening to music, watching moving images, or joining video conferences. The acoustic device includes a speaker driver as an electroacoustic transducer produced by, for example, a microelectromechanical systems (MEMS) technology.

### SUMMARY

The present disclosure described herein provides an improved electroacoustic transducer including a diaphragm, a driver, a support, and a coupler. The diaphragm extends in an extending direction. The driver extends in the extending direction and is opposed to the diaphragm in an opposing direction orthogonal to the extending direction. The driver includes multiple driving sources to vibrate the diaphragm in the opposing direction. The support is disposed at a center of the multiple driving sources in the extending direction to support the driver. Further, the support is disposed in a region where the diaphragm is disposed in the extending direction. The coupler couples the diaphragm and the driver in the opposing direction. Each of the multiple driving sources of the driver extends from the support in the extending direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an electroacoustic transducer according to a first embodiment of the present disclosure;

FIG. 2 is a side view of the electroacoustic transducer of FIG. 1, according to the first embodiment;

FIG. 3 is a plan view of the electroacoustic transducer of FIG. 1, according to the first embodiment, in which the illustration of a diaphragm is omitted;

FIG. 4 is a plan view of an electroacoustic transducer according to a first modification of the first embodiment;

FIG. 5 is a plan view of an electroacoustic transducer according to a second embodiment of the present disclosure;

FIG. 6 is a plan view of an electroacoustic transducer according to a first modification of the second embodiment;

FIG. 7 is a perspective view of the electroacoustic transducer of FIG. 6, according to the first modification of the second embodiment;

FIG. 8 is a plan view of an electroacoustic transducer according to a second modification of the second embodiment;

FIGS. 9A and 9B are plan views of an electroacoustic transducer according to a third embodiment of the present disclosure;

FIGS. 10A and 10B are plan views of an electroacoustic transducer according to a first modification of the third embodiment;

FIGS. 11A and 11B are plan views of an electroacoustic transducer according to a second modification of the third embodiment;

FIG. 12 is a schematic view of an eyeglasses-type wearable device according to a fourth embodiment of the present disclosure;

FIG. 13 is a schematic view of a watch-type wearable device according to a fifth embodiment of the present disclosure;

FIG. 14 is a schematic view of an earphone speaker according to a sixth embodiment of the present disclosure; and

FIG. 15 is a schematic view of an ultrasonic transmitter according to a seventh embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A comparative electroacoustic transducer is produced by the MEMS technology and has a configuration in which an actuator is opposed to a diaphragm. However, in the comparative electroacoustic transducer, a fixed portion is disposed around the diaphragm. According to such a configuration, there is room for improvement in the sound pressure level per arrangement area of the electroacoustic transducer.

Embodiments of the present disclosure are described below with reference to the drawings. In the drawings, like reference signs denote like elements, and redundant or overlapping description thereof may be omitted as appropriate.

Further, the embodiments described below are some examples of an electroacoustic transducer, an array speaker, a wearable device, a speaker, or an ultrasonic transmitter for embodying the technical idea of the present disclosure, and embodiments of the present disclosure are not limited to the embodiments described below.

Unless otherwise specified, shapes of components, relative arrangements thereof, and values of parameters described below are not intended to limit the scope of the present disclosure but are intended to exemplify the scope of the present disclosure. For example, the size and positional relation of components illustrated in the drawings may be exaggerated for clarity of description.

### First Embodiment

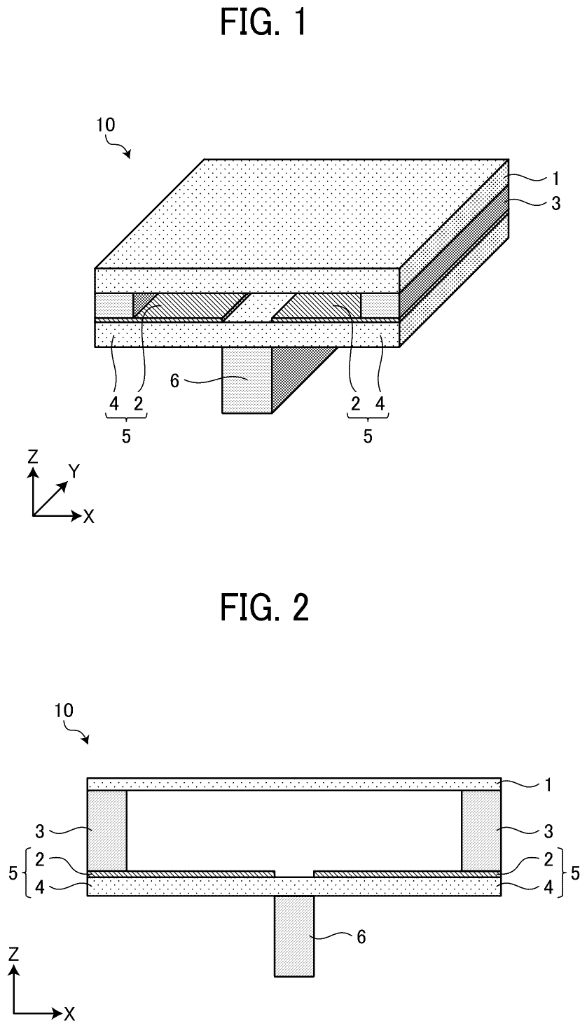

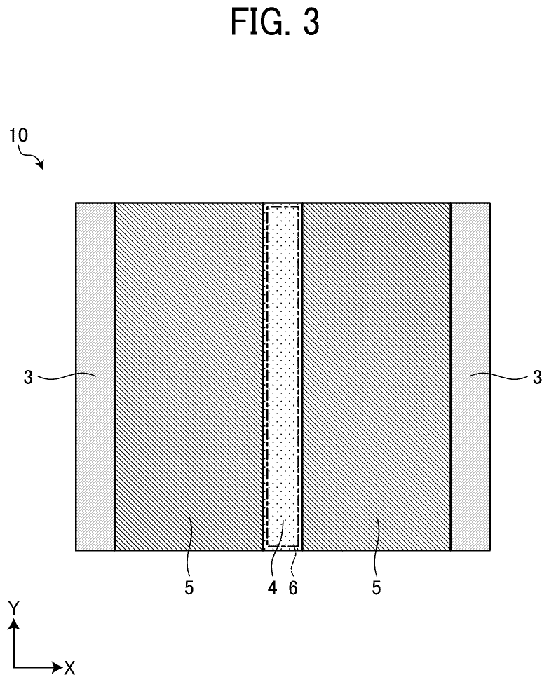

A first embodiment will be described below with reference to FIGS. 1 to 3. FIG. 1 is a perspective view of an electroacoustic transducer according to the first embodiment of the present disclosure. FIG. 2 is a side view of the electroacoustic transducer of FIG. 1, according to the first embodiment. FIG. 3 is a plan view of the electroacoustic transducer of FIG. 1, according to the first embodiment, in which the illustration of a diaphragm is omitted. Arrows illustrated in FIGS. 1 to 3 indicate an X direction, a Y direction, and a Z direction. The X direction, the Y direction, and the Z direction without plus or minus sign include both positive and negative directions.

An electroacoustic transducer 10 illustrated in FIG. 1 includes a diaphragm 1, a driving source 2, a coupler 3, a driving plate 4, and a support 6. A region where the driving source 2 and the driving plate 4 are laminated is referred to as a driver 5.

In the electroacoustic transducer 10, the driver 5 is fixed to the support 6 to support the driver 5, and the driver 5 vibrates around the support 6 as a fixed end in the Z direction (direction in which the diaphragm 1 and the driver 5 are opposed to each other, i.e., a vibration direction, in other words, an opposing direction) by an electrical signal input to the driving source 2. The electroacoustic transducer 10 is a device that generates vibration such as sound by the diaphragm 1 that vibrates in the Z direction in accordance with the vibration of the driver 5. Each part of the electroacoustic transducer 10 will be described below in detail.

The support 6 is a support member having a longitudinal direction in the Y direction. The support 6 is disposed at a region indicated by an alternate long and short dash line in FIG. 3, on the side of the driving plate 4 opposite the driving source 2 as illustrated in FIG. 2. The support 6 has a single-layer structure or a multiple-layer structure formed of, for example, an inorganic material or an organic material. The support 6 is preferably formed of single crystal silicon of a silicon on insulator (SOI) substrate. When the support 6 is formed of multiple layers, an interlayer film formed of, for example, silicon oxide may be disposed between the layers of the support 6 or between the driving plate 4 and the support 6. The driving plate 4 is laminated on the side of the support 6 in the +Z direction. The support 6 may be larger than the region indicated by the alternate long and short dash line in FIG. 3. For example, a part of the region where the support 6 is disposed may overlap the driver 5. Further, for example, the end of the support 6 in the Y direction may project from the driving plate 4.

The driving plate 4 is laminated on the support 6 in the +Z direction, and extends in the +X direction or the −X direction from the support 6 disposed at the center of the driving plate 4 (multiple driving sources 2). The driving plate 4 is formed of, for example, an oxide material, an inorganic material, or an organic material. The driving plate 4 is preferably formed of a silicon active layer. A region of the driving plate 4 extending from the support 6 in the X direction is supported by the support 6, and is elastically deformable around the fixed end in the Z direction like a so-called cantilever structure. A portion of the driving plate 4 laminated on the support 6 is the fixed end. The coupler 3 and multiple driving sources 2 are disposed on the side of the driving plate 4 opposite the support 6.

The coupler 3 is opposed to the driver 5 and the diaphragm 1 in the Z direction, and couples the driver 5 and the diaphragm 1. The coupler 3 has a longitudinal direction which is the same direction as the longitudinal direction of the support 6, and is formed along the side of the driving plate 4 at the end in the X direction (extending direction of the driving plate 4 and the diaphragm 1). The coupler 3 illustrated in FIGS. 1 and 2 is laminated on the driving source 2, but may be laminated on the driving plate 4.

The coupler 3 is not necessarily formed along the side of the driving plate 4 at the end in the X direction. For example, the coupler 3 may be formed on the inner side in the X direction (the center side of the driving plate 4) with respect to the end of the driving plate 4.

The driving source 2 is a piezoelectric actuator that is driven by a voltage applied thereto. The driving source 2 is electrically connected to an external control device that controls a signal for generating vibration such as sound and transmits the signal to the electroacoustic transducer 10. The driving source 2 includes a lower electrode, a piezoelectric body, and an upper electrode laminated in this order on the driving plate 4. The lower electrode and the upper electrode are formed of, for example, gold (Au) or platinum (Pt). The piezoelectric body is formed of, for example, lead zirconate titanate (PZT) which is a piezoelectric material. However, the material forming the piezoelectric body is not limited thereto. The driving source 2 may include multiple layers of the piezoelectric bodies and an intermediate electrode therebetween.

When a voltage is applied to the driving source 2, a strain is generated in the in-plane direction (XY direction) in the piezoelectric body of the driving source 2, and the driver 5 is deformed in the Z direction. The driver 5 is a unimorph formed of the driving source 2 and the driving plate 4. As the voltage applied to the driving source 2 changes with time, the surface of the diaphragm 1 vibrates via the coupler 3 to generate a pressure wave in ambient air, which is sensed by a person as a sound. An input voltage waveform is electrically converted from a waveform of a sound to be reproduced. This voltage waveform is input to the driving source 2 to reproduce the sound.

Multiple drivers 5 in which the driving sources 2 and the driving plate 4 are laminated are line-symmetrical or point-symmetrical with respect to a region in which the driving plate 4 and the support 6 are laminated. The arrangement of the drivers 5 having symmetry can reduce deformation of the diaphragm 1 during vibration.

The diaphragm 1 is a rectangular plate. The diaphragm 1 is joined to the driver 5 via the coupler 3 in the Z direction on two sides opposed to each other in the X direction. In other words, the diaphragm 1 is opposed to the driver 5 and the coupler 3 in the Z direction. The area of the diaphragm 1 as viewed in the Z direction (in plan view) is preferably equal to or larger than the total area of the driving plate 4 and the coupler 3 in plan view. The shape of the diaphragm 1 is not limited to a rectangle, and may be any desired shape.

For example, the diaphragm 1 is formed of silicon by a MEMS process. However, the process and material for forming the diaphragm 1 are not limited thereto. As the material for forming the diaphragm 1, for example, a metal such as magnesium, titanium, or aluminum, carbon nanofibers, cellulose nanofibers, paper, or carbon fiber reinforced plastics (CFRP) can be selected.

According to the present embodiment, the driver 5 and the support 6 are disposed in a region opposed to the diaphragm 1. In particular, the driver 5 and the support 6 are disposed within the region opposed to the diaphragm 1. Such a configuration can arrange the diaphragm 1 without a component surrounding the diaphragm 1. Accordingly, the ratio of the area of the diaphragm 1 to the arrangement area of the electroacoustic transducer 10 can be increased, and the sound pressure level per arrangement area of the electroacoustic transducer 10 can be enhanced. The multiple drivers 5 (multiple driving sources 2) extend from the support 6 disposed at the center of the multiple drivers 5 (multiple driving sources 2). In other words, the driver 5 has a so-called cantilever structure having the fixed end at which the driver 5 is laminated on the support 6, to drive the diaphragm 1. Such a configuration can obtain a large displacement as compared with the configuration in which both ends of the driver 5 are fixed, and thus the amplitude of the vibration of the diaphragm 1 can be increased. As a result, the sound pressure level per unit area of the diaphragm 1 can be enhanced.

The driver 5 drives both ends of the diaphragm 1 via the coupler 3. Such a configuration reduces the distortion of the vibration surface of the diaphragm 1 due to the driving force as compared with the configuration in which the center of the diaphragm 1 is driven, and allows the vibration surface of the diaphragm 1 to vibrate in parallel to the Z direction (vibration direction). As a result, the distortion, i.e., total harmonic distortion (THD) that is generated when the electroacoustic transducer 10 is driven can be reduced.

### First Modification

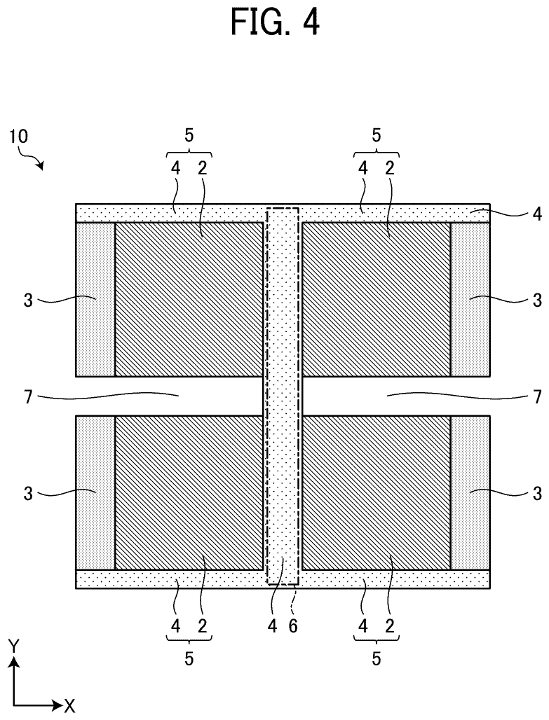

FIG. 4 is a plan view of an electroacoustic transducer according to a first modification of the first embodiment. As illustrated in FIG. 4, the coupler 3 and the driver 5 may be divided by a slit 7 extending in the X direction. The multiple drivers 5 in multiple pairs with respect to the support 6 can change the longitudinal direction of the drivers 5 from the Y direction (direction orthogonal to the extending direction of the driver 5 and the diaphragm 1) to the X direction. Such a configuration increases the ratio of the deformation of the driver 5 in the X direction to the deformation in the Y direction, and thus sound pressure level per unit area of the diaphragm 1 can be enhanced and the THD can be reduced efficiently.

### Second Embodiment

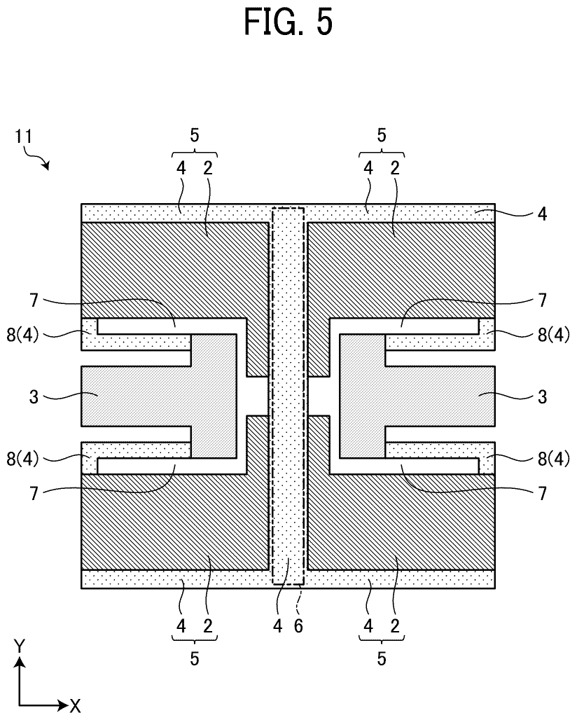

A second embodiment will be described below with reference to FIG. 5. In the following description of the second embodiment, descriptions of elements, which have already been described, identical or similar to those in the first embodiment are omitted, and differences from the first embodiment are described.

FIG. 5 is a plan view of an electroacoustic transducer according to a second embodiment of the present disclosure. In the present embodiment, the diaphragm 1 is the same as that in the first embodiment, and the illustration of the diaphragm 1 is omitted in FIG. 5. An electroacoustic transducer 11 illustrated in FIG. 5 is different from the modification of the first embodiment illustrated in FIG. 4 in that the coupler 3 is disposed between the drivers 5 adjacent to each other in the Y direction. The coupler 3 includes a spring portion 8 (i.e., a spring) that is displaced (displaceable) in the Z direction with respect to the driver 5.

The coupler 3 is disposed near a free end of the driver 5 (at an end in the extending direction) between the pair of the drivers 5 adjacent to each other in the Y direction, i.e., between the adjacent drivers 5 (adjacent multiple driving sources 2). The coupler 3 is coupled to the adjacent drivers 5 via a pair of spring portions 8.

The spring portions 8 are symmetrical with respect to the coupling position of the coupler 3 with the diaphragm 1. The spring portion 8 is formed by a part of the driving plate 4 and has a folded structure from the free end toward the fixed end of the driver 5. Thus, the spring portion 8 can be deformed in the Z direction with respect to the driver 5 with the coupling position between the spring portion 8 and the driver 5 as a rotation axis.

According to the present embodiment, the coupler 3 can be displaced, between the adjacent drivers 5, in the vibration direction of the diaphragm 1 with respect to the driver 5. Due to such a configuration, only the component in the vibration direction of the driving force of the driver 5 is transmitted to the diaphragm 1, and thus the amplitude of the vibration of the diaphragm 1 can be further increased. As a result, the sound pressure level per unit area of the diaphragm 1 can be enhanced. Further, such a configuration reduces the distortion of the vibration surface of the diaphragm 1 due to the driving force as compared with the configuration without the spring portions 8, and allows the vibration surface of the diaphragm 1 to vibrate in parallel to the Z direction (vibration direction). As a result, the distortion that is generated when the electroacoustic transducer 10 is driven can be reduced. The driver 5 has different widths in the direction (i.e., a width direction) orthogonal to the extending direction and the vibration direction between the end of the diaphragm 1 and the support 6 in the extending direction of each driver 5. Specifically, the width of the driver 5 in the transverse direction is smaller near the end of the driver 5 in the extending direction than near the support 6. Such a configuration can prevent an increase in the arrangement area of the electroacoustic transducer 10 due to the spring portion 8.

### First Modification

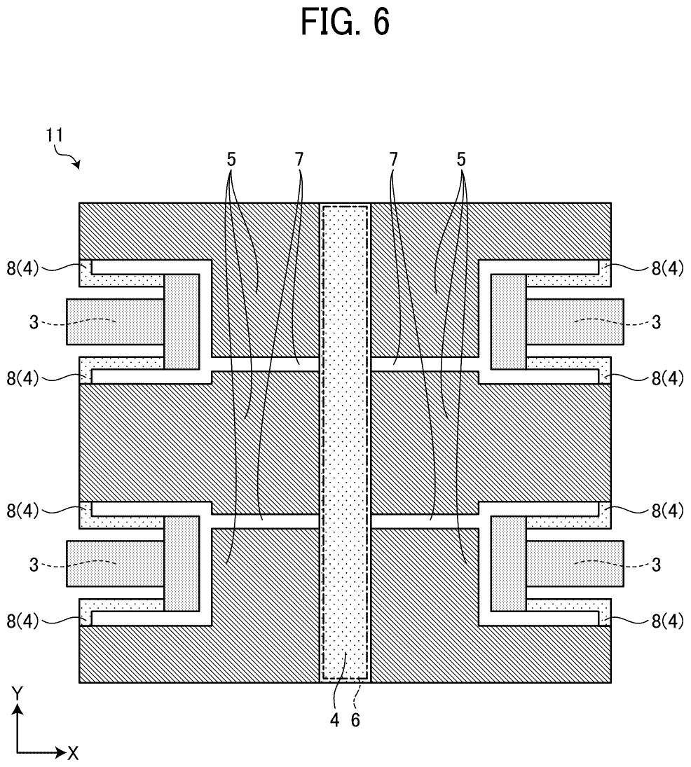

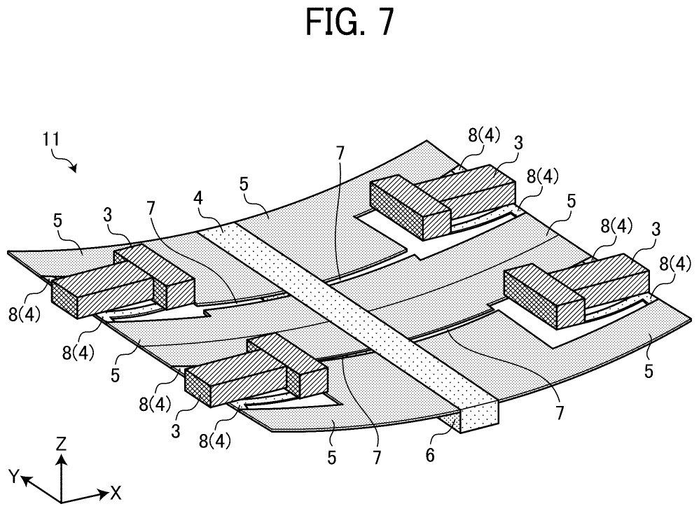

FIG. 6 is a plan view of an electroacoustic transducer according to a first modification of the second embodiment. FIG. 7 is a perspective view of the electroacoustic transducer of FIG. 6, according to the first modification of the second embodiment. As illustrated in FIGS. 6 and 7, the electroacoustic transducer 11 may include three or more pairs of drivers 5 and two or more pairs of couplers 3 each including the spring portion 8. In this case, the ratio of the length of the driver 5 in the X direction to the length of the driver 5 in the Y direction can be increased. Such a configuration increases the ratio of the deformation of the driver 5 in the X direction to the deformation in the Y direction, and thus sound pressure level (may be referred to as the amplitude of the generated vibration) can be enhanced and the THD can be reduced more efficiently. Further, since the diaphragm 1 can be supported by the couplers 3 at more positions, the vibration of the diaphragm 1 can be further stabilized.

### Second Modification

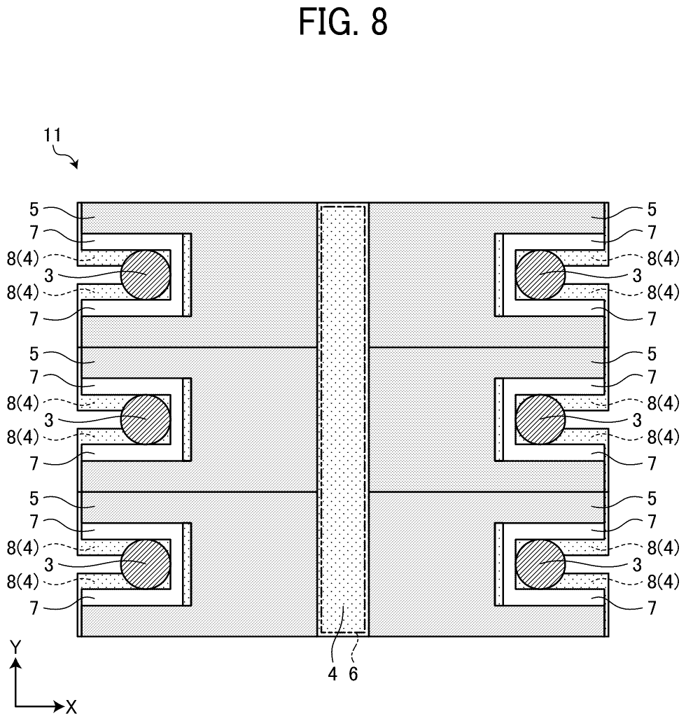

FIG. 8 is a plan view of an electroacoustic transducer according to a second modification of the second embodiment. As illustrated in FIG. 8, the coupler 3 including the spring portion 8 may not necessarily be disposed between the adjacent drivers 5. For example, the coupler 3 including the spring portion 8 may be disposed at the free end of each of the multiple pairs of drivers 5.

### Third Embodiment

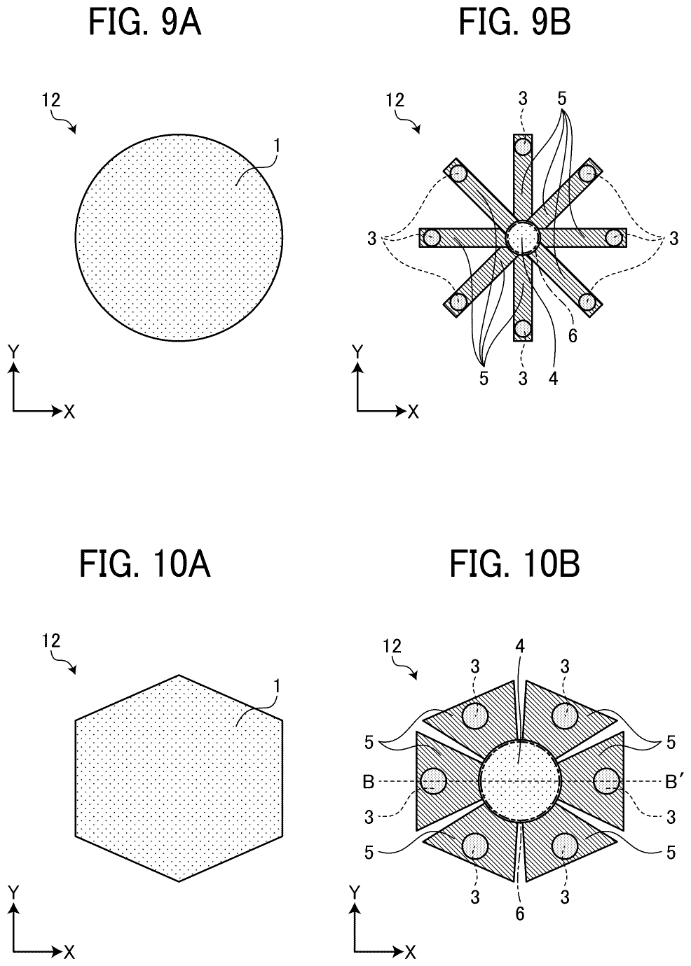

A third embodiment will be described below with reference to FIGS. 9A and 9B. In the following description of the third embodiment, descriptions of elements, which have already been described, identical or similar to those in the first embodiment or the second embodiment are omitted, and differences from the first embodiment and the second embodiment are described.

FIG. 9A is a plan view of an electroacoustic transducer according to the third embodiment of the present disclosure. FIG. 9B is a plan view of the electroacoustic transducer illustrated in FIG. 9A, in which the illustration of the diaphragm is omitted. An electroacoustic transducer 12 illustrated in FIGS. 9A and 9B is different from the electroacoustic transducer 10 of the first embodiment in that the diaphragm 1 is circular. Further, the electroacoustic transducer 12 is different from the electroacoustic transducer 10 of the first embodiment in that the drivers 5 are point-symmetrical with respect to the support 6.

The electroacoustic transducer 12 includes the eight drivers 5 extending radially from the support 6. The eight drivers 5 are point-symmetrical with respect to the support 6. As the drivers 5 having point-symmetry vibrate the diaphragm 1, vibration components in the direction other than the Z direction generated in the respective drivers 5 can be canceled. Such a configuration can vibrate the diaphragm 1 more stably, and thus the THD can be reduced. In the present embodiment, the number of the drivers 5 is not limited to eight, and may be three or more.

The width of each driver 5 in the transverse direction near the end of the diaphragm 1 in the extending direction (may be referred to as the edge of the diaphragm 1) is preferably equal to or larger than the width of the coupler 3. The driver 5 contacts the entire side surface of the coupler 3 to strengthen the contact surface between the driver 5 and the coupler 3. Such a configuration can prevent the damage to the driver 5 due to the vibration of the driver 5. The width of the driver 5 in the transverse direction near the support 6 may be equal to or less than the width of the coupler 3. The driver 5 having the width, in the transverse direction near the support 6, equal to or smaller than the width of the coupler 3 can increase the number of drivers 5 that can be arranged around the support 6, and thus the diaphragm 1 can be vibrated more stably.

### First Modification

FIG. 10A is a plan view of an electroacoustic transducer according to a first modification of the third embodiment. FIG. 10B is a plan view of the electroacoustic transducer illustrated in FIG. 10A, in which the illustration of the diaphragm is omitted. As illustrated in FIG. 10B, each of the drivers 5 having point symmetry may have different widths in the transverse direction between the end of the driver 5 in the extending direction and the support 6. For example, the width in the transverse direction at the end of the driver 5 in the extending direction is larger than the width in the transverse direction near the support 6. Accordingly, the area of the driving source 2 can be increased, and the driving force of the driver 5 can be increased. Such a configuration can enhance the drive sensitivity of the diaphragm 1.

### Second Modification

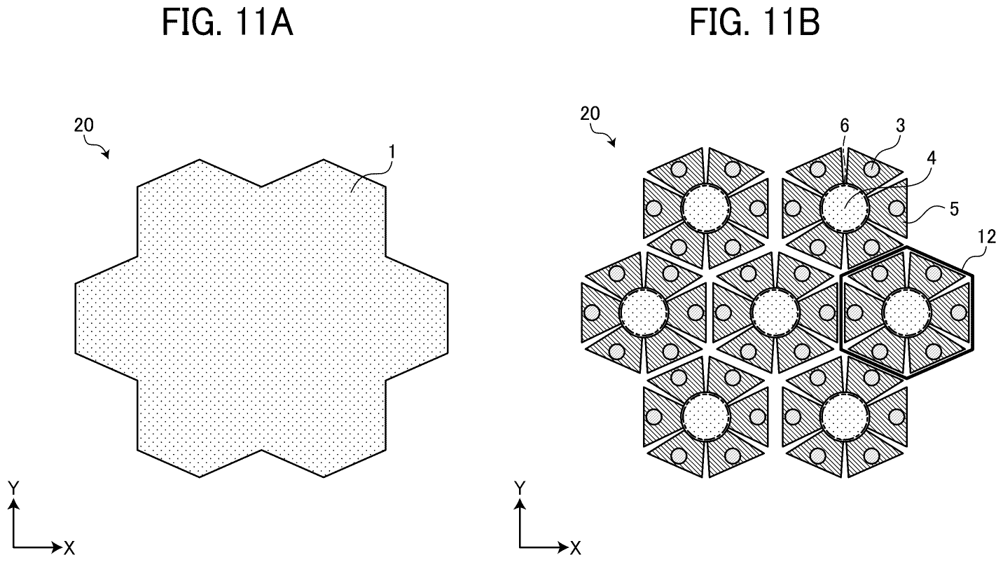

FIG. 11A is a plan view of an electroacoustic transducer according to a second modification of the third embodiment. FIG. 11B is a plan view of the array-type electroacoustic transducer illustrated in FIG. 11A, in which the illustration of the diaphragm of the electroacoustic transducer (e.g., a speaker array) is omitted. An array-type electroacoustic transducer 20 illustrated in FIGS. 11A and 11B includes the multiple electroacoustic transducers 12 illustrated in FIGS. 10A and 10B arranged on the same plane. The multiple electroacoustic transducers arranged on the same plane can enhance the directivity of the generated vibration. In other words, the reaching distance of the vibration generated in the vibration direction of the diaphragm 1 can be further increased. In this case, from the viewpoint of enhancing the directivity of vibration, the multiple electroacoustic transducers 12 are preferably arranged in a close-packed structure such as a triangular lattice.

The diaphragm 1 illustrated in FIG. 11A is formed of a single plate (single piece) having the shape of the combined multiple hexagonal diaphragms 1 illustrated in FIG. 10A, but may be formed of multiple plates.

### Fourth Embodiment

The first to third embodiments described above can be applied not only to the electroacoustic transducer but also to an acoustic device including the electroacoustic transducer, such as an earphone, a headphone, or a speaker. Further, for example, such an acoustic device can be incorporated into a wearable device. The wearable device, such as a wristwatch, eyeglasses, a head-mounted display (HMD), or a body-mounted device, can be directly or indirectly mounted on the human body of a user.

In particular, an acoustic device to be incorporated in a wearable device preferably has a small size and low power consumption from the viewpoint of, for example, a long operation time, reduction in size and weight, and design. The first to third embodiments can enhance the sound pressure level per arrangement area of the electroacoustic transducer and per unit area of the diaphragm. In other words, according to the first to third embodiments, an acoustic device can output a large sound with predetermined power while reducing the size of the electroacoustic transducer. Accordingly, the acoustic device to which the first, second, or third embodiment is applied can prevent the entire wearable device from being increased in size and enhance the flexibility in design. At the same time, the acoustic device to which the first, second, or third embodiment is applied can reduce power consumption when outputting a sound. Applied cases will be described below.

A fourth embodiment will be described below with reference to FIG. 12. In the following description of the fourth embodiment, descriptions of elements, which have already been described, identical or similar to those in the first to third embodiments are omitted, and differences from the first to third embodiments are described.

FIG. 12 is a schematic view of an eyeglasses-type wearable device according to the fourth embodiment of the present disclosure. An eyeglasses-type wearable device 2000 illustrated in FIG. 12 includes speakers 1000 and temples 2001 (i.e., a frame). The speaker 1000 corresponds to the electroacoustic transducer described in the first to third embodiments. When the speaker 1000 is mounted on the eyeglasses-type wearable device 2000, the speaker 1000 is preferably disposed on the inner face of the temple 2001 (i.e., the surface facing the user when the user wears the wearable device). In particular, when the speaker 1000 is used as a bone conduction speaker, the speaker 1000 is preferably disposed at a position, where the surface of the head of the user is in contact with, on the temple 2001.

### Fifth Embodiment

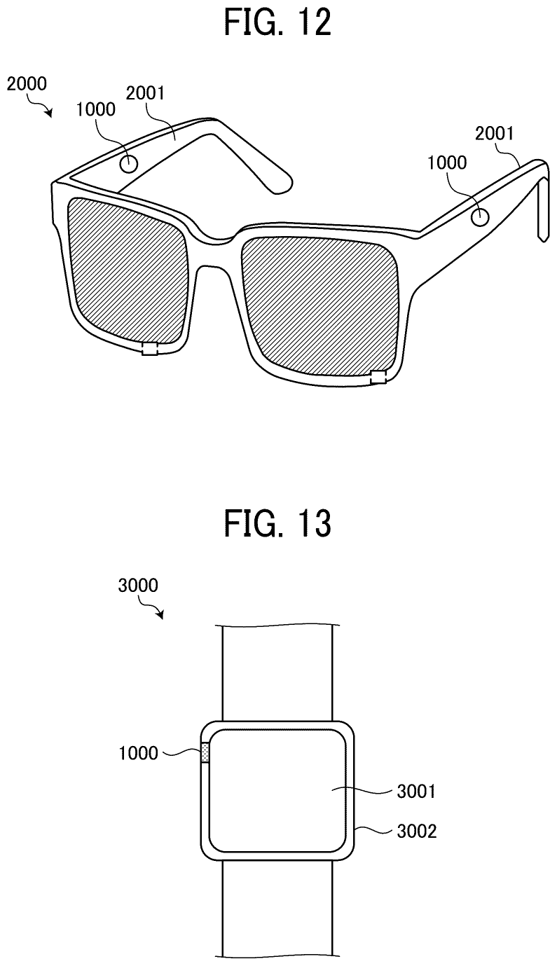

A fifth embodiment will be described below with reference to FIG. 13. In the following description of the fifth embodiment, descriptions of elements, which have already been described, identical or similar to those in the first to third embodiments are omitted, and differences from the first to third embodiments are described.

FIG. 13 is a schematic view of a watch-type wearable device according to the fifth embodiment of the present disclosure. A watch-type wearable device 3000 illustrated in FIG. 13 includes a speaker 1000, a liquid crystal display 3001, and an outer frame 3002 (i.e., a frame) of the liquid crystal display 3001. When the speaker 1000 is mounted on the watch-type wearable device 3000, the speaker 1000 is preferably disposed on the outer frame 3002 of the liquid crystal display 3001.

### Sixth Embodiment

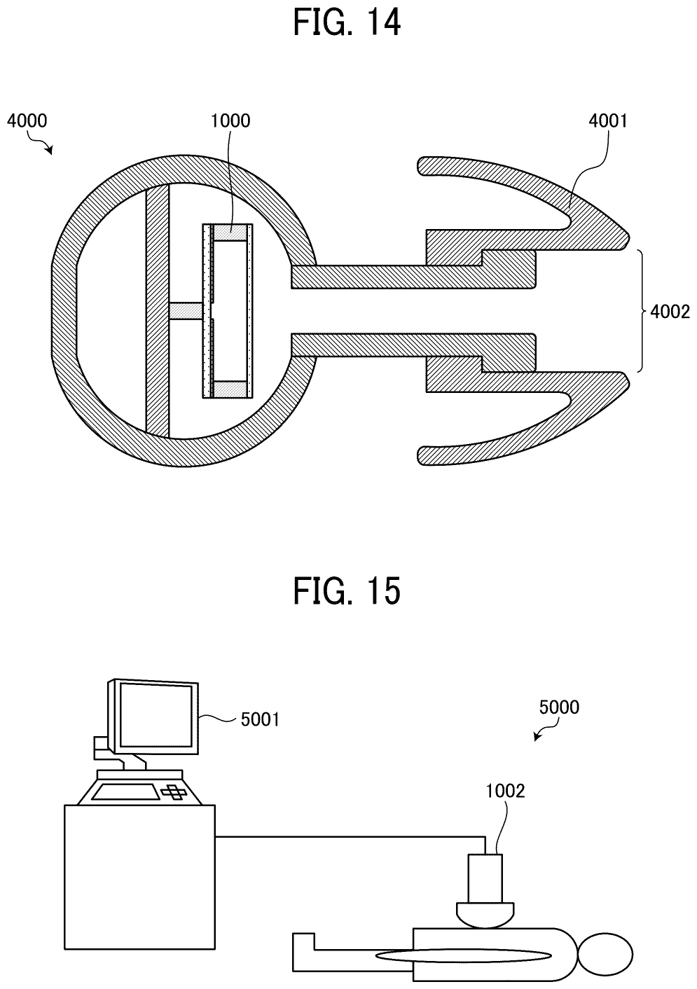

A sixth embodiment will be described below with reference to FIG. 14. In the following description of the sixth embodiment, descriptions of elements, which have already been described, identical or similar to those in the first to third embodiments are omitted, and differences from the first to third embodiments are described.

FIG. 14 is a schematic view of an earphone speaker according to the sixth embodiment of the present disclosure. An earphone speaker 4000 illustrated in FIG. 14 includes a speaker 1000, an attachment portion 4001 (e.g., ear pad, cap, plug, or piece) to be worn over (or inserted into) the ear of the user, and an opening 4002. When the speaker 1000 is mounted on the earphone speaker 4000, the opening 4002 of the attachment portion 4001 to be worn over the ear is preferably disposed on the normal line to the driving plate (or the diaphragm) of the speaker 1000.

### Seventh Embodiment

Further, the electroacoustic transducers according to the first to third embodiments can also be applied to, for example, an ultrasonic transmitter that generates ultrasonic waves by the vibration of the electroacoustic transducer.

A seventh embodiment will be described below with reference to FIG. 15. In the following description of the seventh embodiment, descriptions of elements, which have already been described, identical or similar to those in the first to third embodiments are omitted, and differences from the first to third embodiments are described.

FIG. 15 is a schematic view of an ultrasonic transmitter according to the seventh embodiment of the present disclosure. An ultrasonic transmitter 5000 illustrated in FIG. 15 includes at least an ultrasonic vibrator 1002 and a processing unit 5001. The ultrasonic vibrator 1002 corresponds to the electroacoustic transducer described in the first to third embodiments. The ultrasonic transmitter 5000 outputs ultrasonic waves from the ultrasonic vibrator 1002 based on electrical signals controlled by the processing unit 5001.

Although the electroacoustic transducer according to an embodiment of the present disclosure has been described above, the present disclosure is not limited to the above-described embodiment. Within a range conceivable by those skilled in the art, another embodiment may be added, or elements may be added, changed, or omitted. Any one of such aspects that provides an action and an effect of the present disclosure is within the scope of the present disclosure.

Aspects of the present disclosure are, for example, as follows.

### Aspect 1

An electroacoustic transducer includes a diaphragm, multiple drivers, a support, and a coupler. The multiple drivers are disposed in a region opposed to the diaphragm. The multiple drivers vibrate the diaphragm. The support is disposed in the region opposed to the diaphragm. The support supports the multiple drivers. The coupler couples the diaphragm and each of the multiple drivers. The multiple drivers extends from the support as a center.

In other words, an electroacoustic transducer includes a diaphragm, a driver, a support, and a coupler. The diaphragm extends in an extending direction. The driver extends in the extending direction and is opposed to the diaphragm in an opposing direction orthogonal to the extending direction. The driver includes multiple driving sources to vibrate the diaphragm in the opposing direction. The support is disposed at a center of the multiple driving sources in the extending direction to support the driver. Further, the support is disposed in a region where the diaphragm is disposed in the extending direction. The coupler couples the diaphragm and the driver in the opposing direction. Each of the multiple driving sources of the driver extends from the support in the extending direction.

### Aspect 2

In the electroacoustic transducer according to Aspect 1, the support is disposed in the region opposed to the diaphragm.

In other words, the support is disposed at a center of the diaphragm in the extending direction.

### Aspect 3

In the electroacoustic transducer according to Aspect 1 or 2, the drivers are disposed in the region opposed to the diaphragm.

In other words, the center of the multiple driving sources is aligned at a center of the diaphragm in the extending direction.

### Aspect 4

In the electroacoustic transducer according to any one of Aspects 1 to 3, the coupler is disposed in the region opposed to the diaphragm.

In other words, the coupler is disposed at each end of the diaphragm in the extending direction.

### Aspect 5

In the electroacoustic transducer according to any one of Aspects 1 to 4, the coupler is disposed at an end of the driver in the extending direction.

### Aspect 6

In the electroacoustic transducer according to any one of Aspects 1 to 5, the multiple drivers (multiple driving sources) are line-symmetrical with respect to the support.

### Aspect 7

In the electroacoustic transducer according to any one of Aspects 1 to 5, the multiple drivers (multiple driving sources) are point-symmetrical with respect to the support.

### Aspect 8

In the electroacoustic transducer according to any one of Aspects 1 to 7, multiple pairs of the drivers are provided for the support.

In other words, the multiple driving sources include pairs of driving sources, and the support supports the pairs of driving sources.

### Aspect 9

In the electroacoustic transducer according to Aspect 8, the coupler is disposed between adjacent drivers and couples the adjacent drivers together to the diaphragm.

In other words, the coupler is disposed between adjacent multiple driving sources and couples the adjacent multiple driving sources together to the diaphragm.

### Aspect 10

In the electroacoustic transducer according to any one of Aspects 1 to 9, the coupler includes a spring portion that is displaced in the vibration direction of the diaphragm with respect to the drivers.

In other words, the coupler includes a spring displaceable in the opposing direction with respect to the driver.

### Aspect 11

In the electroacoustic transducer according to any one of Aspects 1 to 10, each of the multiple drivers has different widths in a direction orthogonal to the extending direction of each of the multiple drivers between an end of the diaphragm and the support in the extending direction.

In other words, each of the multiple driving sources has different widths in a width direction orthogonal to the extending direction and the opposing direction, between an end of the diaphragm and the support in the extending direction.

### Aspect 12

In the electroacoustic transducer according to any one of Aspects 1 to 11, a width of the end of each of the drivers in the extending direction is equal to or larger than a width of the coupler.

In other words, a width of each of the multiple driving sources at an end of each of the multiple driving sources in the extending direction is equal to or larger than a width of the coupler.

### Aspect 13

In the electroacoustic transducer according to any one of Aspects 1 to 12, the diaphragm includes either one of silicon, magnesium, titanium, aluminum, carbon nanofiber, cellulose nanofiber, paper, or carbon fiber reinforced plastics (CFRP).

### Aspect 14

An array speaker includes the multiple electroacoustic transducers according to any one of Aspects 1 to 13.

In other word, an array speaker includes multiple electroacoustic transducers including the electroacoustic transducer according to any one of Aspects 1 to 13.

### Aspect 15

The array speaker according to Aspect 14, the diaphragm of the multiple electroacoustic transducers is formed into a single piece.

### Aspect 16

A wearable device includes the electroacoustic transducer according to any one of Aspects 1 to 13.

In other word, a wearable device includes the electroacoustic transducer according to any one of Aspects 1 to 13 and a frame mounting the electroacoustic transducer.

### Aspect 17

A speaker includes the electroacoustic transducer according to any one of Aspects 1 to 13.

In other word, a speaker includes the electroacoustic transducer according to any one of Aspects 1 to 13 and an opening disposed on a normal line to the diaphragm to output a sound.

### Aspect 18

An ultrasonic transmitter includes the electroacoustic transducer according to any one of Aspects 1 to 13.

In other word, an ultrasonic transmitter includes the electroacoustic transducer according to any one of Aspects 1 to 13. The electroacoustic transducer outputs ultrasonic waves.

As described above, according to one aspect of the present disclosure, an electroacoustic transducer can be provided that has an enhanced sound pressure level per arrangement area of the electroacoustic transducer.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An electroacoustic transducer comprising:
a diaphragm extending in an extending direction;
a driver:
extending in the extending direction;
opposed to the diaphragm in an opposing direction orthogonal to the extending direction; and
including multiple driving sources to vibrate the diaphragm in the opposing direction;
a support:
at a center of the multiple driving sources in the extending direction to support the driver; and
in a region where the diaphragm is disposed in the extending direction; and
a coupler coupling the diaphragm and the driver in the opposing direction,
each of the multiple driving sources of the driver extending from the support in the extending direction.

2. The electroacoustic transducer according to claim 1,
wherein the support is at a center of the diaphragm in the extending direction.

3. The electroacoustic transducer according to claim 1,
wherein the center of the multiple driving sources is aligned at a center of the diaphragm in the extending direction.

4. The electroacoustic transducer according to claim 1,
wherein the coupler is disposed at each end of the diaphragm in the extending direction.

5. The electroacoustic transducer according to claim 1,
wherein the coupler is disposed at an end of the driver in the extending direction.

6. The electroacoustic transducer according to claim 1,
wherein the multiple driving sources are line-symmetrical with respect to the support.

7. The electroacoustic transducer according to claim 1,
wherein the multiple driving sources are point-symmetrical with respect to the support.

8. The electroacoustic transducer according to claim 6,
wherein the multiple driving sources include pairs of driving sources, and
the support supports the pairs of driving sources.

9. The electroacoustic transducer according to claim 8,
wherein the coupler:
is disposed between adjacent multiple driving sources; and
couples the adjacent multiple driving sources together to the diaphragm.

10. The electroacoustic transducer according to claim 1,
wherein the coupler includes a spring displaceable in the opposing direction with respect to the driver.

11. The electroacoustic transducer according to claim 1,
wherein each of the multiple driving sources has different widths in a width direction orthogonal to the extending direction and the opposing direction, between an end of the diaphragm and the support in the extending direction.

12. The electroacoustic transducer according to claim 1,
wherein a width of each of the multiple driving sources at an end of each of the multiple driving sources in the extending direction is equal to or larger than a width of the coupler.

13. The electroacoustic transducer according to claim 1,
wherein the diaphragm includes either one of silicon, magnesium, titanium, aluminum, carbon nanofiber, cellulose nanofiber, paper, or carbon fiber reinforced plastics.

14. An array speaker comprising multiple electroacoustic transducers including the electroacoustic transducer according to claim 1.

15. The array speaker according to claim 14,
wherein the diaphragm of the multiple electroacoustic transducers is formed into a single piece.

16. A wearable device comprising:
the electroacoustic transducer according to claim 1; and
a frame mounting the electroacoustic transducer.

17. A speaker comprising:
the electroacoustic transducer according to claim 1; and
an opening disposed on a normal line to the diaphragm to output a sound.

18. An ultrasonic transmitter comprising the electroacoustic transducer according to claim 1,
wherein the electroacoustic transducer outputs ultrasonic waves.
